(19) United States
(12) Patent Application Publication
(10) Pub. No.: US 2009/0022644 A1
(43) Pub. Date: Jan. 22, 2009

(54) Method for the absorption of harmful substances and odors

(76) Inventor: Robert Sweredjuk, Reicholzried-Dietmannsried (DE)

Correspondence Address: COLLARD & ROE, P.C., 1077 NORTHERN BOULEVARD, ROSLYN, NY, 11576, US

(21) Appl. No.: 12/224,404

(22) PCT Filed: Feb. 27, 2007
(86) PCT No.: PCT/EP2007/051858

§ 371 Date: Aug. 26, 2008

(30) Foreign Application Priority Data
Mar. 1, 2006 (DE) 10 2006 009 847.1

(51) Int. Cl. B01D 53/02

(52) U.S. Cl. 423/245.1

(57) ABSTRACT

Disclosed is a method for absorbing harmful substances, especially aldehydes, volatile organic compounds (VOC), and odors and permanently protecting particularly ambient air from said harmful substances. According to said method, a protein-reactive substance is provided at least in the proximity of emitters of harmful substances or potential emitters of harmful substances.

The invention relates to a process for the absorption of pollutants, particularly aldehydes, volatile organic compounds (VOC) and odours, and for the permanent protection, particularly of room air, against such pollutants.

Various processes and apparatuses have been disclosed with which it is possible to remove pollutants from ambient media such as room air for a short period of time. These pollutants primarily include aldehydes, the most well-known example of which is formaldehyde.

All of these processes disclosed up to now have the disadvantage, however, that they do not have any permanent impact. Although the activated charcoal that is often used assimilates relatively large amounts of pollutants very quickly, for example, it releases them again at least to some extent depending on the ambient conditions. This re-release is encouraged primary by high temperatures. Activated charcoal is therefore a good way to adsorb pollutants quickly, but it is not capable of absorbing the adsorbed pollutants afterwards as well, i.e. of removing and making them harmless on a permanent basis.

This problem arises with all the other processes disclosed in the past as well. The absorption that is the real aim is not achieved. It is always the case that only reversible adsorption takes place.

The purpose of the invention is to propose a process that enables pollutants to be eliminated permanently.

In the solution to this problem proposed by the invention, a protein-reactive substance is provided at least in the proximity of pollutant emitters and/or potential pollutant emitters.

Pollutants are quickly removed from the surroundings as a result, on the one hand, while they are, on the other hand, embedded in the protein-reactive substance and thus made harmless on a permanent basis. There is no undesirable pollutant release.

It has proved to be extremely advantageous in this context if a protein hydrolysate and in particular enzymatically degraded scleroproteins are used as the protein-reactive substance.

Protein hydrolysates and in particular enzymatically degraded scleroproteins have proved to be particularly advantageous in carrying out the assignment for which the invention has been developed.

In accordance with another further development of the invention, it is very advantageous if the protein-reactive substance is used in liquid, pasty, viscous or powdery form.

Many different applications are possible as a result.

In another very advantageous further development of the invention, the protein-reactive substance contains additives.

It has proved to be extremely advantageous in this context if urea, zeolites, aluminium oxide, inorganic photocatalysts and/or preservatives etc. are added.

The protein-reactive substance can be adapted to the pollutants in question especially well with the help of such additives in particular.

In another very advantageous further development of the invention, the protein-reactive substance is spray dried before it is used.

Further application areas are opened up in turn as a result. The substance is straightforward to store and transport as well.

The process according to the invention is also implemented in a very advantageous way if the protein-reactive substance is applied to a substrate, an object, a coating, a coating system etc.

It is also very advantageous if the protein-reactive substance is incorporated in a substrate, an object, a coating etc.

There are many unobtrusive possible applications as a result, in which the pollutants can be assimilated directly where they are emitted as well.

It is also extremely advantageous in accordance with the invention if the protein-reactive substance is incorporated in dyes, inks, paints, lacquers, coatings, stains, plasters etc.

It is as a result very simple to apply the protein-reactive substance retroactively as well.

In another very advantageous further development of the process in accordance with the invention, the protein-reactive substance is provided in detergents and cleaning agents.

This enables objects that emit pollutants to be treated quickly. Any pollutants in the detergents and cleaning agents are in addition prevented from escaping into the environment.

In accordance with another further development of the process, it is also very advantageous if the protein-reactive substance is provided in impregnation agents and/or fibre coatings, particularly for textiles etc.

This means that textiles emitting pollutants originating in dyes, for example, can be treated simply, quickly and inexpensively.

It has also proved to be extremely advantageous in accordance with the invention if the protein-reactive substance is used in wall, ceiling and/or floor coverings.

Polluted rooms can be restored not only thoroughly but also simply and quickly as a result.

One embodiment of the invention is outlined below.

Many of the building materials in standard use nowadays, such as chipboard, plasterboard and floor coverings as well as wall and ceiling panels made in particular from wood and wooden materials, emit such pollutants as aldehydes and other volatile organic compounds.

These emissions have the unwelcome side-effect, which is extremely hazardous to health in minimum-energy houses in particular where there is very little exchange of air, that these substances collect in the room air and are assimilated by people.

There is not unfortunately any easy way simply to leave these pollutants out in production of the building materials, however.

These pollutants are formed from natural contents of the wood, particularly when coniferous wood is being processed. Thermal, thermal-hydrolytic and oxidative processes and reactions occur during the processing operations, that lead to the formation of aldehydes and volatile organic compounds (VOC). The most well-known example of the aldehydes is formaldehyde, that can be found in sizeable quantities in chipboard and OSB in particular, in which other aldehydes and VOCs are also found. It is often the case that the official limits for formaldehyde in particular are even exceeded considerably.

The process in accordance with the invention provides a permanent solution to this problem: emission of pollutants from the objects treated using this solution is prevented, while any pollutants that have escaped even so are removed from the room air too.

A protein-reactive substance, preferably in the form of an aqueous protein hydrolysate solution is applied to the wood chips during the board production process. After the excess moisture has dried, a thin film of the protein-reactive substance is left on the surface of the wood chips. This protein-reactive substance absorbs the pollutants that escape from the wood chips directly. Sufficient reactants in the form of residual amino acids are available which enable the pollutants to complete their reactions, so that they are chemically bonded in the protein-reactive substance.

This thin film of the protein-reactive substance also represents an effective diffusion barrier for the pollutants, so that they cannot under any circumstances escape from the wood chips. The water vapour diffusion that also occurs is not impeded by this protective film, however.

In most cases, the thin film is extremely elastic, so that it withstands mechanical stresses too.

It is, however, also conceivable for the protein-reactive substance to be applied subsequently or to be mixed in a bonding agent for the boards that are to be formed.

It is also conceivable for the protein-reactive substance to be embedded in dyes, inks, paints, lacquers, stains, wood protection agents, coatings, artificial resins (particularly artificial resin coatings), plasters etc., so that the same protective effect as already outlined above can be achieved on application. Then it is possible to treat wall and floor coverings after they have been laid too.

It is, however, also conceivable for the protein-reactive substance to be used in plasterboard or plaster fibreboard, but also in plasters and other coatings.

It is conceivable in addition for the protein-reactive substance to be added to cleaning agents and detergents, as a result of which a protective layer is applied or renewed in every cleaning operation.

It is also conceivable in this context for enzymes contained in detergents and cleaning agents (e.g. proteases, lipases, amylases) to be modified in such a way that these agents can be used as a protein-reactive substance too. In cleaning agents and detergents, enzymes are only used in the area of their active core, i.e. only a specific group of amino acids within the enzyme is active in the sense of having a cleaning effect. In accordance with the invention, the residual amino acids that are not part of the active core can be used to absorb and eliminate pollutants. These residual amino acids can be modified in such a way that pollutant elimination is made possible or is improved considerably. Such enzymes then have the conventional properties, on the one hand, and now have the additional function of absorbing and eliminating pollutants.

Textile materials or papers can also be provided with the protein-reactive substance, as a result of which vapour barriers, wallpaper etc. can be used at the same time to eliminate pollutants and/or odours.

The protein-reactive substance can be used in liquid form, as a powder, as a paste or in an aqueous solution. The choice of the specific form of administration depends essentially on the application in question. A powder can, for example, be obtained by spray drying the liquid substance.

This means that the protein-reactive substance can be used in many different ways. Selective coating of either individual or several layers of a multilayer material or specific individual parts of a multilayer material, such as chips, veneers, films etc., is conceivable, for example.

The protein-reactive substance can also be doped/mixed with further substances, such as urea, zeolites, certain preservatives etc., as a result of which the receptivity level for specific pollutants/odours can be influenced and adapted.

The concentration of this doping depends, on the one hand, on the concentration of the pollutants that are present and, on the other hand, on the pollutant category.

The speed of the reaction process until the pollutants have completed their reaction and/or have been neutralised can also depend on the pH level of the protein-reactive substance, however.

The protein-reactive substance can be configured to be more or less adhesive for certain applications. An adhesive finish can be produced by long molecular chains.

Excellent pollutant/odour absorption is still achieved even when the protein-reactive substance is only applied partially or the protective layer produced is damaged.

The pollutants and/or odours are adsorbed by the protein-reactive substance first of all, i.e. they are reversibly bonded (physisorbed), and are absorbed in a further stage of reaction (chemisorbed), which means that reaction and bonding are completed with appropriate reactants of the reactive substance. Reaction is a process that takes considerably longer to complete than adsorption, so that the two processes initially take place superimposed. There is essentially no release of the adsorbed pollutant/odour molecules, however, since absorption also takes place immediately, so that there is no time for the adsorbed molecules to be released again.

1: Process for the absorption of pollutants, particularly aldehydes, volatile organic compounds (VOC) and odours, and for the permanent protection, particularly of room air, against such pollutants, wherein a protein-reactive substance is provided at least in the proximity of pollutant emitters and/or potential pollutant emitters.

2. Process according to claim 1, wherein a protein hydrolysate and in particular enzymatically degraded scleroproteins are used as the protein-reactive substance.

3. Process according to claim 1, wherein the protein-reactive substance is used in liquid, pasty, viscous or powdery form.

4. Process according to claim 1, wherein the protein-reactive substance contains additives.

5. Process according to claim 4, wherein urea, zeolites, aluminium oxide, inorganic photocatalysts and/or preservatives etc. are added.

6. Process according to claim 1, wherein the protein-reactive substance is spray dried before it is used.

7. Process according to claim 1, wherein the protein-reactive substance is applied to a substrate, an object, a coating, a coating system etc.

8. Process according to claim 1, wherein the protein-reactive substance is incorporated in a substrate, an object, a coating etc.

9. Process according to claim 1, wherein the protein-reactive substance is incorporated in dyes, inks, paints, lacquers, coatings, stains, plasters etc.

10. Process according to claim 1, wherein the protein-reactive substance is provided in detergents and cleaning agents.

11. Process according to claim 10, wherein enzymes contained in cleaning agents are modified.

12. Process according to claim 11, wherein the enzymes are modified in such a way in their passive area that the residual amino acids there can absorb and eliminate pollutants.

13. Process according to claim 1, wherein the protein-reactive substance is provided in impregnation agents and/or fibre coatings, particularly for textiles etc.

14. Process according to claim 1, wherein the protein-reactive substance is used in wall, ceiling and/or floor coverings, structural paneling, e.g. OSB panels etc.
